(19) United States
(12) Patent Application Publication
(10) Pub. No.: US 2011/0176859 A1
(43) Pub. Date: Jul. 21, 2011

(54) Speedy Pivoting-and-Fixing Device for Foldable Structure

(76) Inventor: Shao-Hua Chu, Taipei (TW)

(21) Appl. No.: 12/690,692

(22) Filed: Jan. 20, 2010

(51) Int. Cl. F16B 7/00

(52) U.S. Cl. 403/91

(57) ABSTRACT

A speedy pivoting-and-fixing device for a foldable structure includes a structure assembly, a pivot assembly, a base assembly and a pin. The structure assembly has a first structure and a second structure. The pivot assembly has a first pivot and a second pivot formed with axial holes. The first and the second pivots are each formed with a cambered surface at a connected end thereof so that the first and the second structures can be pivoted by 90° and 180° relatively. The base assembly has through-holes corresponding to the axial holes so that, by using bolts, the base assembly can be effectively attached to the pivot assembly or the first and the second pivots can be pivoted into place in a speedy way. The pin is disposed at a side of the first and the second pivot and is adapted to compressively fix the pivot assembly to prevent rotation thereof.

### BACKGROUND OF THE INVENTION

1. Technical Field

The present invention relates to a speedy pivoting-and-fixing device for a foldable structure, and more particularly, to a pivoting device that allows for various frame structures to be joined in a speedy and convenient way and, when being folded, securely positioned into place.

2. Description of Related Art

Currently, existing foldable structures such as those of foldable bicycle frames, foldable cat ladders, foldable tables & chairs, foldable sport equipment, foldable lamps, foldable beds, foldable sun shields/rain sheds, foldable handles, foldable foot stands, foldable connecting links and the like, mostly fail to provide an ideal speedy pivoting-and-fixing device. Consequently, it is impossible to join, release or pivotally fold the structures in a speedy way by means of an identical mechanism, making it impossible for the folded structures to be completely secured against loosening.

For example, a foldable bicycle currently available mostly has drawbacks that, after being folded, it has very bulky volume and large thickness and the bicycle frame is unable to be fixed. In order for the bicycle frame to be folded, the foldable bicycle is typically provided with a joint at a folding position of the bicycle frame so that, by virtue of the joining property of the joint that it allows for detachment of a bicycle skeleton, the bicycle body can be folded conveniently and so that the bicycle skeleton can be re-joined together for use by means of the joint.

As a key mechanism for folding a bicycle, the joint must be made to be safe in structure, convenient to operate, and miniaturized in volume and lightweight. However, existing joints for bicycle frames fail to satisfy all these requirements. In other words, they either have excessively huge volume, width or weight or require use of a tool in operation, or otherwise, operation thereof is time- and labor-consuming and complex. Furthermore, the bicycle frame as folded cannot be fixed directly by use of the existing joint mechanism, making the bicycle body very unstable and inconvenient to carry about, which is known as a prominent drawback of the prior art. Accordingly, it is a focus of development in the art to develop a speedy pivoting-and-fixing device for a foldable structure that is safe in use, small in volume and width, lightweight, easy and speedy to operate, and capable of effectively fixing the folded structure.

As another example, many foldable cat ladders currently available have drawbacks that pivoting-and-fixing devices of their frames have inadequate joining strength when being unfolded and the cat ladders are unable to be effectively fixed when being folded. Accordingly, it is also a focus of development in the art to develop a speedy pivoting-and-fixing device for a foldable cat ladder that is easier, safer and speedier to operate.

### BRIEF SUMMARY OF THE INVENTION

The primary objective of the present invention is to provide a speedy pivoting-and-fixing device for a foldable structure, which allows for a structure to be unfolded through a pivoting movement to an included angle of 90° or 180° and is also capable of completely fix the folded structure against loosening. Accordingly, the speedy pivoting-and-fixing device of the present invention features a simple structure, small volume, a narrow width, high safety, and simple operation.

Another objective of the speedy pivoting-and-fixing device for a foldable structure of the present invention is to provide a novel structure that is different from all conventional speedy pivoting-and-fixing devices for a foldable structure.

For further understanding of the objectives, structural features and other effects of the present invention, a detailed description will be made hereinafter with reference to the attached drawings.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a top view of a first embodiment of the present invention in a joined status;

FIG. 2 is a front view of the first embodiment of the present invention in the joined status;

FIG. 3 is a side view of the first embodiment of the present invention in the joined status;

FIG. 4 is a lateral cross-sectional view of the first embodiment of the present invention in the joined status;

FIG. 5 is a longitudinal cross-sectional view of the first embodiment of the present invention in the joined status;

FIG. 6 is a side cross-sectional view of the first embodiment of the present invention in the joined status;

FIG. 7 is a lateral cross-sectional view of the first embodiment of the present invention when being folded by 90° but having not been joined and fixed;

FIG. 8 is a lateral cross-sectional view of the first embodiment of the present invention when being folded by 180° and having been joined and fixed;

FIG. 9 is a top view of a second embodiment of the present invention in a joined status;

FIG. 10 is a front view of the second embodiment of the present invention in the joined status;

FIG. 11 is a side view of the second embodiment of the present invention in the joined status;

FIG. 12 is a lateral cross-sectional view of the second embodiment of the present invention in the joined status;

FIG. 13 is a longitudinal cross-sectional view of the second embodiment of the present invention in the joined status;

FIG. 14 is a side cross-sectional view of the second embodiment of the present invention in the joined status;

FIG. 15 is a lateral cross-sectional view of the second embodiment of the present invention when being folded by 90° but having not been joined and fixed; and

FIG. 16 is a lateral cross-sectional view of the second embodiment of the present invention when being folded by 180° and having been joined and fixed.

### DETAILED DESCRIPTION OF THE INVENTION

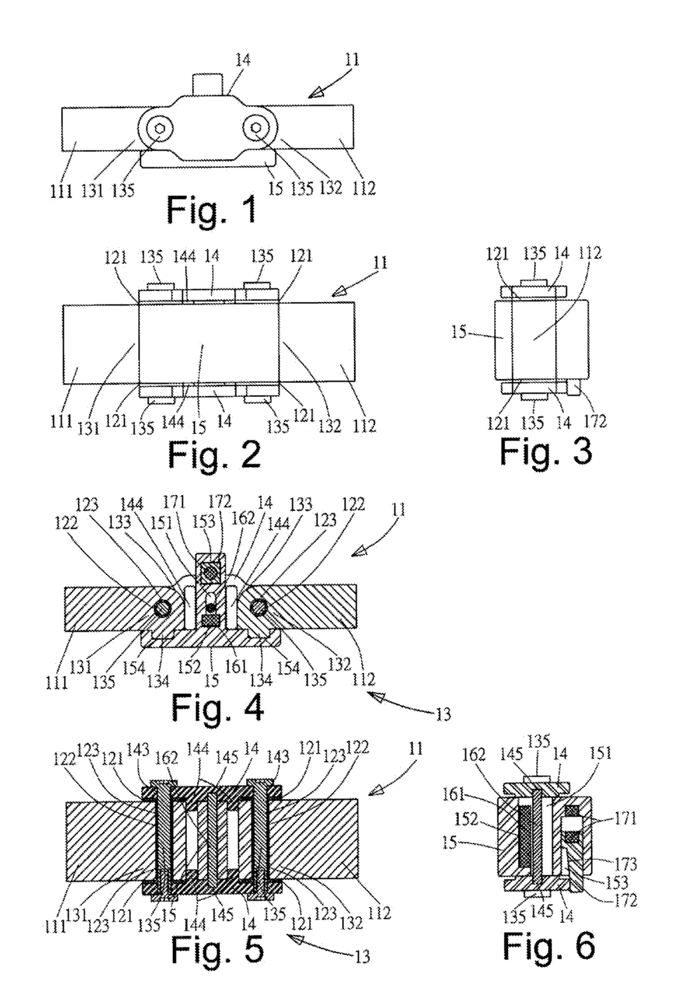

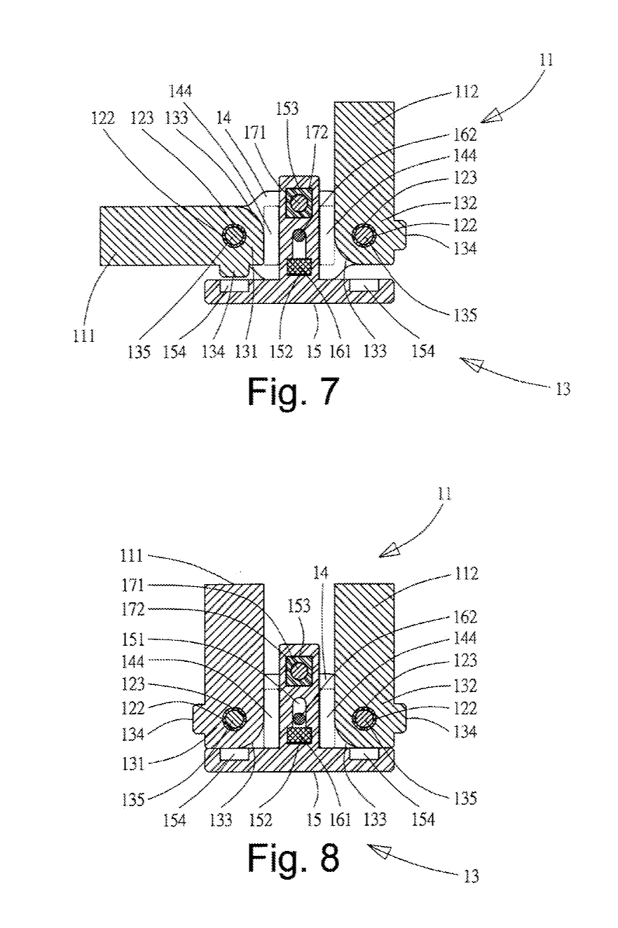

FIGS. 1 to 8 illustrate a first embodiment of a speedy pivoting-and-fixing device for a foldable structure of the present invention. The speedy pivoting-and-fixing device for a foldable structure mainly comprises a structure assembly 11, a pivot assembly 13, a base assembly 14 and a pin 15.

The structure assembly 11 comprises a first structure 111 and a second structure 112. The pivot assembly 13 comprises a first pivot 131 and a second pivot 132 disposed at connected ends of the first and the second structures 111, 112 respectively. Each of the first pivot 131 and the second pivot 132 is formed with an axial hole 122, and may be formed with a cambered surface 133 at a connected end thereof so that the first structure 111 and the second structure 112 of the structure assembly 11 can be pivoted by 90° and 180° relative to each other. Tenons 134 may be disposed on the first and the second pivots 131, 132 at positions where the first and the second pivots 131, 132 are joined to the pin 15, while recesses 154 may be formed on the pin 15 at positions where the pin 15 is joined to the first and the second pivots 131, 132. Bearings 121 are disposed at interfaces between the first and the second pivots 131, 132 and the base assembly 14, and bearings 123 may also be disposed inside the axial holes 122 of the first and the second pivots 131, 132.

On the base assembly 14, through-holes 143 corresponding to the axial holes 122 of the first and the second pivots 131, 132 are formed so that, by means of bolts 135, the base assembly 14 can be effectively attached to the first and the second pivots 131, 132 or the first and the second pivots 131, 132 can be pivoted into place in a speedy way. The base assembly 14 is formed with a flange 144. The flange 144 may function to fix and prevent the first and the second pivots 131, 132 from rotating or pivoting, and may also act as a support against which the pin 15 or a guide slot disposed in the pin 15 can abut when applying a force to compressively fix the pivot assembly 13. The pin 15 fixes the first and the second pivots 131, 132 against loosening in a compressive way.

As shown in FIGS. 4 to 6, the pin 15 is of a T-shaped configuration and is provided with a magnetic compressing assembly 16 and a pressing fastener assembly 17 for preventing loosening. The magnetic compressing assembly 16 is comprised of a magnet 161 and a central column 162 made of a steel material. The central column 162 is inserted through a central column guide slot 151 of the pin 15, with two ends of the central column 162 being disposed into central column holes 145 of the base assembly 14. The magnet 161 is disposed into a hollow magnet chamber 152 of the pin so that, by means of the magnetic force generated between the magnet 161 and the central column 162, a compressive force can be generated to compress the pin 15 against the pivot assembly 13 to prevent loosening of the pivot assembly 13. The pressing fastener assembly 17 is comprised of a magnet assembly 171 that can provide a repulsion force and a pressing fastener 172. The magnet assembly 171 is an elastic component and may also be replaced by a common spring. The pressing fastener assembly 17 is disposed in a hollow pressing fastener chamber 153 of the pin 15. The pressing fastener assembly 17 may also serve a compressive function so that, by means of the repulsion force of the magnet assembly 171, a bevel 173 of the pressing fastener 172 can be compressed against the base assembly 14. Thus, a pushing and compressing effect is generated by the pressing fastener 172 so that the pressing fastener assembly 17 can fasten the pin 15 to effectively prevent loosening of the pin 15.

As shown in FIGS. 6 to 8, if one desires to loosen and fold the first and the second structures, he or she only needs to push the pressing fastener 172 with a hand so that the pressing fastener 172 is released from being blocked by the base assembly 14 and then pushes the pin 15 to the locating point so that the first and the second pivots 131, 132 are released from being compressed by the pin 15. Thus, the first and the second structures can be loosened to pivot the first and the second pivots 131, 132 by 90° or 180°. More particularly, after the first and the second pivots 131, 132 have pivoted by 90° or 180° and folded, the user can push the pin 15 to abut against the first and the second pivots 131, 132 again, at which point the pressing fastener 172 will spring back to fasten the pin 15 so that the pivot assembly 13 will be fixed again as being compressed by the pin 15 without possibility of getting loose.

According to the speedy pivoting-and-fixing device for a foldable structure of this embodiment of the present invention, by pushing the pressing fastener 172 and moving the pin 15, the first and the second structures can be folded and fixed properly in a speedy way. When it is desired to restore the original joining status, simply pushing the pressing fastener 172 can release the first and the second pivots 131, 132 and pivot the first and the second pivots 131, 132 by 90° or 180° to the locating point. Then, by moving the pin 15, the pin 15 is joined tightly to the first and the second pivots 131, 132 so that, by means of the magnetic force generated between the magnet 161 and the central column 162, a compressive force can be generated. Furthermore, after the pressing fastener 172 springs back, the pin 15 can be fastened so that the first and the second pivots 131, 132 can be fixed tightly by the pin 15, thereby accomplishing the operations of joining and fixing the first and the second structures. As the speedy pivoting-and-fixing device for a foldable structure of the present invention has two compressive forces that can prevent loosening, it has superior safety performance and is effective in preventing undesired consequences caused by a false touch. Moreover, it has a sturdy structure and allows for quick and simple operation.

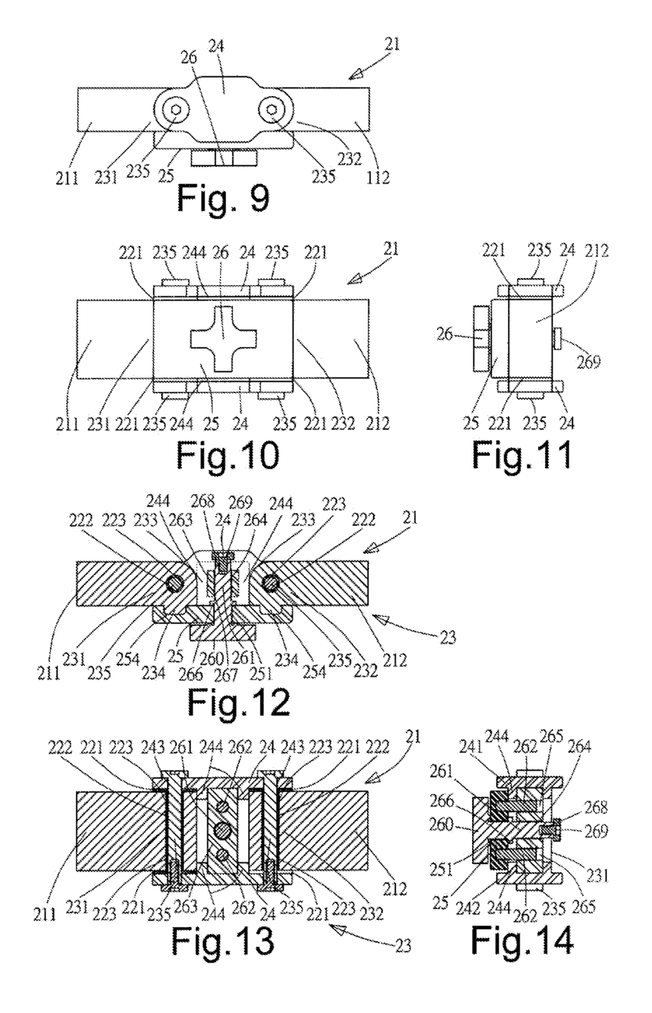

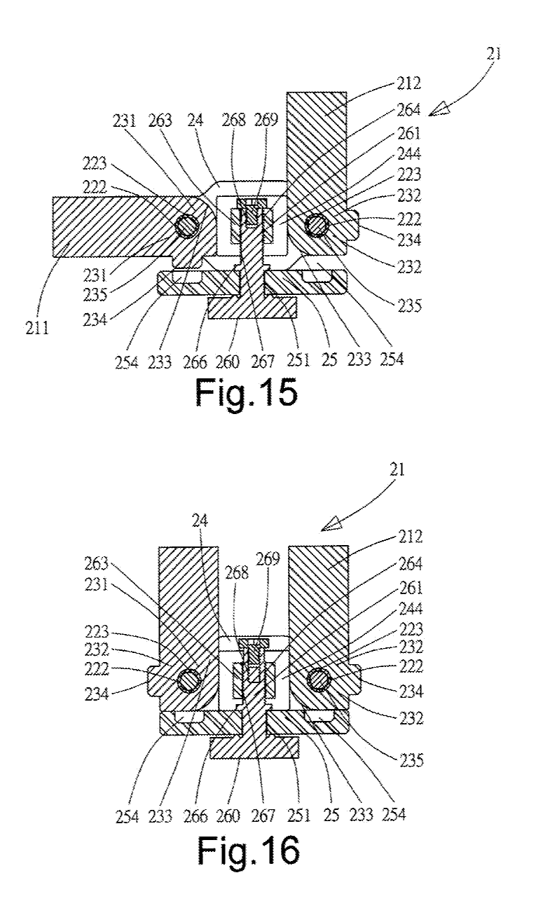

FIGS. 9 to 16 illustrate a second embodiment of the speedy pivoting-and-fixing device for a foldable structure of the present invention. The speedy pivoting-and-fixing device for a foldable structure of this embodiment mainly comprises a structure assembly 21, a pivot assembly 23, a base assembly 24 and a pin 25.

The structure assembly 21 comprises a first structure 211 and a second structure 212. The pivot assembly 23 comprises a first pivot 231 and a second pivot 232 disposed at connected ends of the first and the second structures 211, 212 respectively. Each of the first pivot 231 and the second pivot 232 is formed with an axial hole 222, and may be formed with a cambered surface 233 at a connected end thereof so that the first structure 211 and the second structure 212 of the structure assembly 21 can be pivoted by 90° and 180° relative to each other. Tenons 234 may be disposed on the first and the second pivots 231, 232 at positions where the first and the second pivots 231, 232 are joined to the pin 25, while recesses 254 may be formed on the pin 25 at positions where the pin 25 is joined to the first and the second pivots 231, 232. Bearings 221 are disposed at interfaces between the first and the second pivots 231, 232 and the base assembly 24, and bearings 223 may also be disposed inside the axial holes 222 of the first and the second pivots 231, 232.

On the base assembly 24, through-holes 243 corresponding to the axial holes 222 of the first and the second pivots 231, 232 are formed so that, by means of bolts 235, the base assembly 24 can be effectively attached to the first and the second pivots 231, 232 or the first and the second pivots 231, 232 can be pivoted into place in a speedy way. The base assembly 24 is formed with a flange 244. The flange 244 may function to fix and prevent the first and the second pivots 231, 232 from rotating or pivoting, and may also act as a support against which the pin 25 or a guide slot disposed in the pin 25 can abut when applying a force to compressively fix the pivot assembly 23. The pin 25 fixes the first and the second pivots 231, 232 against loosening in a compressive way.

As shown in FIGS. 12 to 14, the pin 25 is of a slab-shaped configuration and is provided with a compressing screw assembly 26. The compressing screw assembly 26 is comprised of a screw head 260, a screw 261, a guide rod 262, a central column 263 and so on. The screw head 260 and the screw 261 are fixedly joined together. The central column 263 is disposed at an inner side of a flange 244 of the base assembly 24 and is formed with a threaded hole 264 and a guide rod hole 265. The screw 261 is inserted through a screw axial hole 251 of the pin 25 and is provided at a middle section thereof with an annular protrusion 266 so that the pin 25 is disposed between the screw head 260 and the annular protrusion 266. A threaded end 267 of the screw 261 is threaded into the threaded hole 264 of the central column 263, and an internal thread 268 and a male screw 269 are provided at a distal end of the screw 261. The male screw 269 may function to prevent the compressing screw assembly 26 from coming off and to loosen the compressing screw assembly 26 for setting the maximum travel distance. The guide rod 262 is threaded into the pin 25 and is inserted through the guide rod hole 265 of the central column 263 so that the pin 25 will not rotate and shift when moving back and forth with the screw head 260 and the screw 261.

As shown in FIGS. 14 to 16, if one desires to loosen and fold the first and the second structures, he or she only needs to rotate the screw head 260 with a hand so that the screw 261 is loosened to the locating point and, meanwhile, the pin 25 is also loosened to the locating point. Thus, the first and the second pivots 231, 232 are released from being compressed by the pin 25, and the first and the second structures 211, 212 can be pivoted by 90° or 180° and folded. After the first and the second structures 211, 212 have been pivoted by 90° or 180° and folded, the user can rotate the screw head 260 with a hand again and tighten the screw 261 so that the pin 25 abuts against the first and the second pivots 231, 232 again, at which time the first and the second pivots 231, 232 are fixed again as being compressed by the pin 25 without possibility of getting loose. When it is desired to unfold and join the folded first and second structures 211, 212, by simply performing the same operations to loosen and tighten the screw head 260, the first and the second structures 211, 212 can be pivoted to be unfolded and joined in a speed way.

According to the speedy pivoting-and-fixing device for a foldable structure of this embodiment of the present invention, by loosening and tightening the screw head 260 and the screw 261, the first and the second pivots 231, 232 can be pivoted in a speedy way to fold and fix or to join and fix the structure assembly 21 properly. As the speedy pivoting-and-fixing device for a foldable structure of the present invention adopts a threaded connection which provides a powerful compressive force, it has superior safety performance and is effective in preventing undesired consequences caused by a false touch. Moreover, it has a sturdy structure and allows for quick and simple operation.

In summary, the speedy pivoting-and-fixing device of the present invention may be used for various foldable structures to reliably prevent the foldable structures from loosening in a safe and convenient way. It may be used in various facilities such as foldable bicycle frames, foldable cat ladders, foldable tables & chairs, foldable sport equipment, foldable lamps, foldable beds, foldable sun shields/rain sheds, foldable handles, foldable foot stands, foldable connecting links and the like. Thus, the present invention has completely accomplished the aforesaid objectives of the present invention. With great inventiveness and novelty, the present invention surely satisfies elements of a patent of invention, so it is now filed in accordance with the patent law. However, the above descriptions are only provided as preferred embodiments of the present invention, and all equivalent modifications and alterations made by those skilled in the art according to the spirits of the present invention will still fall within scope of the claims of the present invention.

1. A speedy pivoting-and-fixing device for a foldable structure, the speedy pivoting-and-fixing device being capable of joining and fixing a foldable truss structure, and comprising:
a structure assembly comprising a first structure and a second structure;
a pivot assembly comprising a first pivot and a second pivot disposed at connected ends of the first and the second structures, respectively, and formed with an axial hole, respectively;
a base assembly being attached to the first and the second pivots by means of bolts; and
a pin being disposed on a side of the pivot assembly and adapted to fix the first and the second pivots in a compressive way to effectively fix the first and the second structures against loosening no matter the first and the second structures are in a located and joined status or in a folded status after being pivoted by 90° and 180°.

2. The speedy pivoting-and-fixing device of claim 1, wherein each of the first and the second pivots is formed with a cambered surface at a connected end thereof so that the first and the second structures are allowed to pivot by 90° and 180° relative to each other, bearings being disposed at interfaces between the first and the second pivots and the base assembly, and additional bearings being disposed inside the axial holes of the first and the second pivots.

3. The speedy pivoting-and-fixing device of claim 1, wherein tenons are disposed on the first and the second pivots at positions where the first and the second pivots are joined to the pin, while recesses are formed on the pin at positions where the pin are joined to the first and the second pivots, and the tenons and the recesses mate with each other.

4. The speedy pivoting-and-fixing device of claim 1, wherein a force applied to compressively fix the pin to the first and the second pivots is a spiral thrust force, an elastic force, a friction force, a magnetic force or a combination thereof.

5. The speedy pivoting-and-fixing device of claim 1, wherein the base assembly is formed with a flange which functions to fix and prevent the first and the second pivots from rotating or pivoting.

6. The speedy pivoting-and-fixing device of claim 5, wherein the flange of the base assembly functions as a support against which the pin or a guide slot disposed in the pin abuts when applying a force to compressively fix the pivot assembly.

7. The speedy pivoting-and-fixing device of claim 1, wherein the pin is of a T-shaped configuration and is provided with a magnetic compressing assembly and a pressing fastener assembly for preventing loosening.

8. The speedy pivoting-and-fixing device of claim 7, wherein the magnetic compressing assembly of the pin is comprised of a magnet and a central column, the central column being inserted through a central column guide slot of the pin and fixed in a central column hole of the base assembly, the magnet being disposed into a hollow magnet chamber of the pin, the pressing fastener assembly being comprised of a pressing fastener and a magnet assembly having a repulsion force or a spring, and the pressing fastener assembly being disposed in a hollow pressing fastener chamber of the pin.

9. The speedy pivoting-and-fixing device of claim 1, wherein the pin is of a slab-shaped configuration and is provided with a compressing screw assembly.

10. The speedy pivoting-and-fixing device of claim 9, wherein the compressing screw assembly of the pin is comprised of a screw head, a screw, a guide rod and a central column, the central column being fixedly disposed at an inner side of the flange of the base assembly and formed with a threaded hole and a guide rod hole, the screw being inserted through the pin and threaded into the threaded hole of the central column, and the guide rod being threaded into the pin and can slide in the guide rod hole of the central column.
